(19) United States
(12) Patent Application Publication
(10) Pub. No.: US 2009/0277229 A1
(43) Pub. Date: Nov. 12, 2009

(54) System and Method for Restraining a Person

(76) Inventor: James C. Smith, Smyrna, GA (US)

Correspondence Address: DORITY & MANNING, P.A., POST OFFICE BOX 1449, GREENVILLE, SC, 29602-1449, US

(21) Appl. No.: 12/118,902

(22) Filed: May 12, 2008

(51) Int. Cl. E05B 75/00

(52) U.S. Cl. 70/16

(57) ABSTRACT

A system and method for safely and effectively restraining a person having hands restrained by handcuffs joined by a connecting element is disclosed. An enclosure is placed around the hands and handcuffs the person to be secured. The enclosure includes a pair of walls defining an opening, each wall having a top peripheral edge and an aperture spaced apart from the top peripheral edge. A fastening element is extended through the apertures of the walls and fastened to restrict the movement of the hands and handcuffs of the person. The fastening element encircles the opening and top peripheral edges of the walls of the enclosure but does not encircle the connecting element of the handcuffs.

### TECHNICAL FIELD OF THE INVENTION

The present invention relates to a system and method for restraining a person having hands restrained by handcuffs.

### BACKGROUND OF THE INVENTION

It is often necessary for medical, paramedical, and law enforcement personnel to safely restrict the physical movement of a person for a variety of reasons. For example, law enforcement officers and similar personnel may need to restrain a prisoner, suspect, or other person for purposes of arrest, transportation, or detainment. It is important that a law enforcement officer be able to safely restrain a prisoner, suspect or other person as quickly and conveniently as possible to prevent potential harm to the law enforcement officer, to the person being restrained, or to the general public.

Handcuffs and similar hand restraint devices are often used to restrain the physical movement of a person brought into custody. Handcuffs are applied around a person's wrists to secure the person's hands together either in front of or behind the person's back. In this manner, the physical movement of the person in custody is partially restrained. However, restraining a person with handcuffs alone has inherent deficiencies and may create a false sense of security for the law enforcement officer.

Handcuffs only provide limited physical restraint over a prisoner, suspect, or other person in custody. In particular, the handcuffs still allow limited use of the person's hands and fingers. This has in many instances allowed prisoners to escape or to destroy evidence after being placed in custody. Prisoners have also used their hands to gain access to weapons leading in harm or in some cases death to law enforcement personnel. The legs of a person restrained by handcuffs alone are also free, creating an increased risk that the person in custody will escape. For instance, a prisoner can slide through the handcuffs or alternatively step through the handcuffs creating a substantial threat to law enforcement personnel. It is thus desirable to provide a method and system for restraining a person that overcomes the deficiencies in securing a person with handcuffs alone.

Attempts in the past have been made to provide a system for restraining a person having hands restrained by handcuffs. For instance, U.S. Pat. No. 4,741,051 to Bible discloses a protective mitt for use with handcuffs. According to this disclosure, a mitt formed from two opposing fabric walls is placed over the hands of the person to be secured. The mitt includes a flap carried on one of the fabric wall panels which passes over the opposite fabric wall panel. A tab is carried by the opposite fabric wall panel over which the flap is positioned for retention. A tie means is threaded through four separate holes in the protective mitt and beneath the central chain portion of the handcuffs to provide the securement means which separates the hands of the wearer and confines the hands and handcuffs in the mitt. The protective mitt according to U.S. Pat. No. 4,741,051 has its disadvantages. For example, the tie means must be threaded through four separate holes and the flap, tie means, and tab must all be positioned correctly in order to properly secure the hands and handcuffs of the person. In this regard, the protective mitt is relatively complex and difficult to put on a violent or uncooperative person. Moreover, the tie means must be threaded around the chain connecting the handcuffs creating even more difficulty in securing a violent or uncooperative person.

The present invention overcomes these disadvantages by providing a simple, compact system and method for restraint that can be used safely, quickly, and conveniently to effectively restrain a person.

### THE SUMMARY OF THE INVENTION

Objects and advantages of the invention will be set forth in part in the following description, or may be obvious from the description, or may be learned through practice of the invention.

An exemplary embodiment of the present invention provides a restraint system for securing a person having hands restrained by handcuffs. The handcuffs are joined by a connecting element. The restraint system includes an enclosure configured to receive and surround the handcuffs and hands of the person and has pair of walls defining an opening for insertion and removal of the handcuffs and hands. The walls have a top peripheral edge and define an aperture spaced below the top peripheral edge. A fastening element is extended through each aperture of the pair of walls and encircles the opening and top peripheral edges of the pair of walls. The fastening element does not encircle the connecting element of the handcuffs.

In variations of this particular embodiment, each aperture of the pair of walls may be a grommet formed from a polymer. In another variation, one of the pair of walls may be formed from a transparent vinyl material. In another variation, the pair of walls may be formed from a treated vinyl material configured to retain bodily fluids and residue from the hands of the person to be secured. In yet another variation, the enclosure may define a base and may further comprise a seam extending from the base to a position spaced below each aperture of the pair of walls. The seam connects the pair of walls so that the hands of the person are separated from each other when the enclosure receives and surrounds the handcuffs and hands of the person.

In yet another variation of this particular embodiment, the restraint may include a belt having a restraining loop. The belt is connected to the enclosure by extending the fastening element through the restraining loop and each aperture of the pair of walls. The belt may also have a pair of holes. The belt is secured to the person by threading a fastener through the pair of holes.

In still another variation of this particular embodiment, the restraint may include a leg wrap having a fabric member configured to be completely wrapped around the legs of the person. The fabric member extends from an upper position just below the person's knees to a lower position between the person's knees and ankles. The leg wrap includes a pair of straps connected to the fabric member. The leg wrap is secured to the person by fastening the pair of straps.

Another exemplary embodiment of the present invention provides a method for securing a person having hands restrained by a pair of handcuffs. The handcuffs are connected by a connecting element. The method includes placing an enclosure around the hands and handcuffs so that the enclosure surrounds the handcuffs and hands of the person. The enclosure has a pair of walls defining an opening for insertion and removal of the handcuffs and hands. Each wall has a top peripheral edge and an aperture spaced apart from the top peripheral edge. The method includes extending a fastening element through each aperture of the pair of walls and encircling the opening and top peripheral edges of the pair of walls. The fastening element does not encircle the connecting element of the handcuffs. The method includes fastening the fastening element to restrict the movement of the handcuffs and hands of the person.

In variations of this particular embodiment, the method may include connecting a belt having a restraining loop and at least one pair of holes to the enclosure by extending the fastening element through the restraining loop and each aperture of the pair of walls. The belt is secured to the person by extending a fastener through each of the holes.

In another variation of this particular embodiment, the method may include wrapping a leg wrap around the legs of the person. The leg wrap includes a fabric member configured to be completely wrapped around the legs of the person. The fabric member extends from an upper position below the person's knees to a lower position between the person's knees and ankles when wrapped around the legs of the person. The leg wrap has a pair of straps connected to the fabric member. The method includes securing the leg wrap to the person by fastening the straps connected to the fabric member.

Another exemplary embodiment of the present invention provides a restraint for securing a person having hands secured by hand restraints joined by a linking member. The restraint includes a leg wrap member defining an upper portion and a lower portion. The leg wrap member includes a fastening strap connected to the upper portion and a fastening strap connected to the lower portion. The leg wrap member is configured to be completely wrapped around the legs of the person. The upper portion of the leg wrap is located below the person's knees and the lower portion of the leg wrap is located between the person's knees and ankles when wrapped around the legs of the person.

In variations of this exemplary embodiment, the restraint may include a fabric enclosure configured receive and surround the hand restraints and hands of the person. The fabric enclosure has a pair of opposing walls. The opposing walls define an opening for insertion and removal of the hand restraints and hands. Each opposing wall defines a top peripheral edge and an aperture spaced below the top peripheral edge. A fastening element extends through each aperture of the pair of walls and encircles the opening and top peripheral edges of the pair of walls. The fastening element does not encircle the link member of the hand restraints.

In another variation of this exemplary embodiment, the restraint further comprises a belt. The belt includes a securing loop. The belt is connected to the fabric enclosure by extending the fastening element through the securing loop and each aperture of the pair of walls.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present subject matter, including the best mode thereof, directed to one of ordinary skill in the art, is set forth in the specification, which makes reference to the appended figures, in which:

FIG. 1 depicts components of a restraint system according to an exemplary embodiment of the present invention;

FIG. 2A depicts a front view of an exemplary embodiment of the present invention securing the hands of a person;

FIG. 2B depicts a front view of an alternate exemplary embodiment of the present invention securing the hands of a person;

FIG. 3 depicts a perspective view of an exemplary embodiment of the present invention that includes an exemplary belt secured to the person; and

FIG. 4 depicts a perspective view of an exemplary embodiment of the present invention that includes a belt secured to the person and an exemplary leg wrap secured to the person.

### DETAILED DESCRIPTION

Objects and advantages of the invention will be set forth in the following description, or may be apparent from the description, or may be learned through practice of the invention.

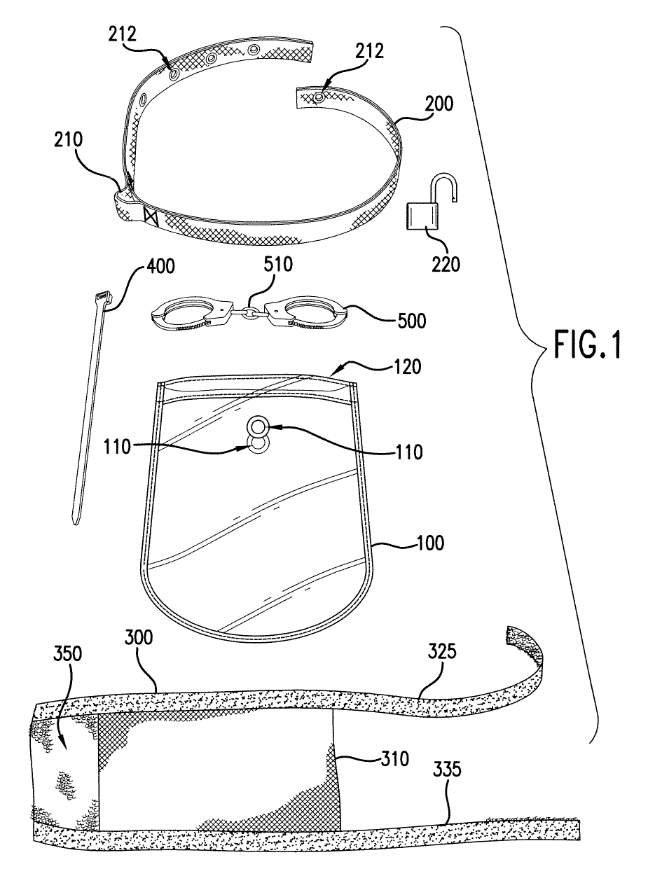

Referring now to FIG. 1, various components of a restraint system according to exemplary embodiments of the present invention are shown. These various components include an enclosure 100, a belt 200, a fastener 220, a leg wrap 300, and a fastening element 400. The restraint system according to the present invention may utilize any one of the above components either standing alone or in combination with one another as described in more detail herein.

The particular embodiment of the restraint system depicted in FIG. 1 includes handcuffs 500 used to secure a person's hands together either in front of or behind the person's back. The handcuffs 500 are joined by a connecting element 510. The handcuffs 500 depicted in FIG. 1 are joined by a connecting element 510 that comprises a chain. However, the present invention is not limited to any particular type of handcuffs, and using the teachings disclosed herein, one of ordinary skill in the art will understand that the present invention may be used with a variety of different types of hand restraints including hinge handcuffs, or handcuffs formed from lock ties.

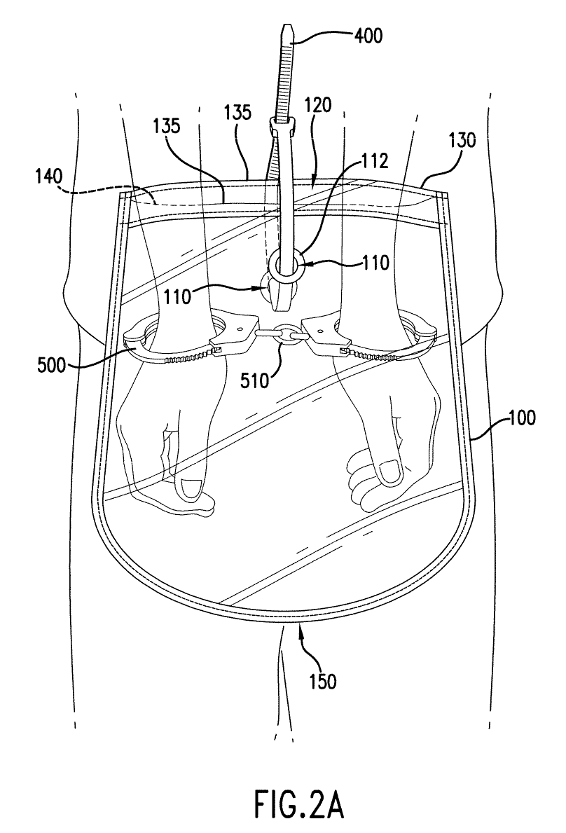

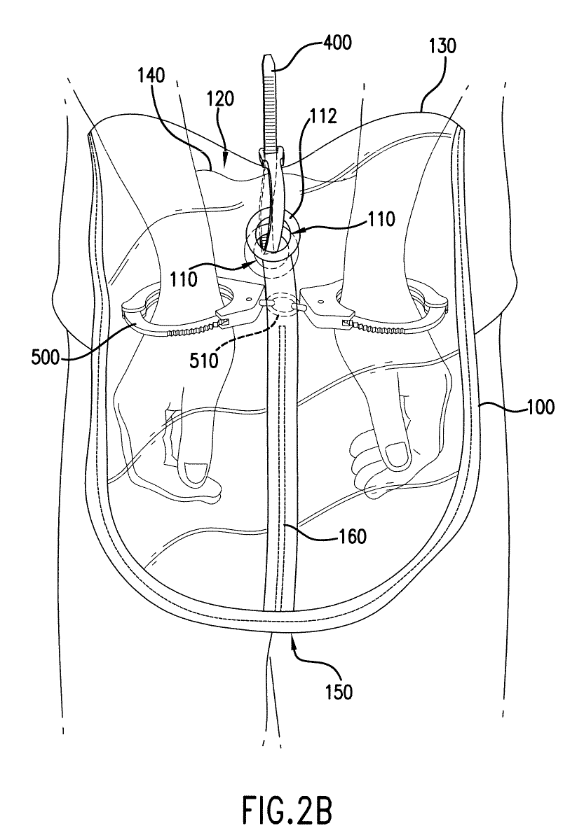

Referring now to FIG. 2A, an exemplary embodiment of a restraint system according to the present invention includes an enclosure 100 configured to receive the hands and handcuffs 500 of the person. The enclosure 100 has a pair of walls 130 and 140 that are connected to one another in a U-shape along the base 150 and sides of the enclosure 100 and define an opening 120. The opening 120 is configured to receive the hands and handcuffs 500 of the person to be secured. The size of the enclosure 100 and opening 120 can vary depending on the size of the person to be restrained. For example, the enclosure 100 may include a modified stitch (not shown) located near the opening 120 of the enclosure 100 that reduces the size of the opening 120 allowing the enclosure 100 to effectively restrain a person of smaller size.

The walls 130 and 140 may be formed from various materials. An exemplary embodiment of the enclosure 100 includes walls 130 and 140 formed from a fabric material such as a vented mesh material that allows air to flow in and out of the enclosure 100. In another exemplary embodiment, the wall 130 may be formed from a transparent vinyl material so that law enforcement or medical personnel may observe the hands and handcuffs 500 of the person to be secured. In this particular embodiment the opposing wall 140 is preferably formed from a vented mesh material so that air can flow inside the enclosure 100. In another exemplary embodiment, the walls 130 and 140 are formed from a treated synthetic material, such as a Tyvek® material produced by Dupont, or other material configured to retain bodily fluids and residue from the hands of the person to be secured. This allows law enforcement personnel to capture DNA and other evidence from the person by simply using the enclosure 100 configured according to this particular embodiment of the present invention.

The walls 130 and 140 each define a peripheral edge 135 and an aperture 110. Each aperture 110 is spaced below the peripheral edge 135 of each respective wall 130 and 140. In the exemplary embodiment depicted in FIG. 2, the apertures 110 comprise grommets 112. These grommets 112 may be formed from a metal such as brass or a polymer material. In one exemplary embodiment, the grommets are formed from a polymer material so that the medical personnel can perform an MRI on the person to be secured without having to remove the restraint system. A polymer grommet also allows a person to be transported through a metal detector with minimal difficulty.

The operation of the restraint system according to the exemplary embodiment depicted in FIG. 2A will now be described in greater detail. The enclosure 100 is placed around the hands and handcuffs 500 of the person to be secured. A fastening element 400 is then extended through the apertures 110 of the walls 130 and 140. The fastening element 400 depicted in FIG. 2 is a lock tie. However, those of ordinary skill in the art will appreciate that the present invention is not limited to any particular type of fastening element and using the teachings disclosed herein, other fastening elements known in the art may be utilized.

The fastening element 400 is positioned so that it encircles the peripheral edge 135 of each wall 130 and 140 of the enclosure 100. The fastening element 400 is also positioned so that it does not encircle the connecting element 510 of the handcuffs 500. This ensures that the connecting element 510 of the handcuffs 500 remains below the fastening element 400. Once the fastening element 400 is positioned correctly, the fastening element 400 is tightened and secured to restrict the movement of the hands and handcuffs 500 of the person. Because the fastening element 400 is positioned above the connecting element 510 of the handcuffs 500, the fastening element 400 impedes the person from removing the hands and handcuffs 500 from the enclosure 100.

The exemplary embodiment of the present invention depicted in FIG. 2A can be used to restrain a person quickly and conveniently. The fastening element 400 only has to be threaded through two apertures 110 and does not have to be positioned around the connecting element 510 of the handcuffs 500. In this regard, the restraint system can be used safely and quickly to restrain a violent or uncooperative person with minimal difficulty.

Referring now to FIG. 2B, an alternate embodiment of the present invention provides an enclosure 100 that further includes a seam 160 extending from the base 150 of the enclosure 100 to a position spaced below the apertures 110 of the walls 130 and 140. The seam 160 connects the walls 130 and 140 to one another so that the hands of the person are separated when the enclosure 100 receives the hands and handcuffs 500 of the person. The seam 160 only extends to a position spaced below the apertures 110 of the walls 130 and 140 so that the seam 160 does not interfere with the connecting element 510 of the handcuffs 500. By separating the hands of the person to be secured, the seam 160 further impedes the ability of a person secured by this particular embodiment from creating harm or danger to law enforcement, medical or paramedical personnel.

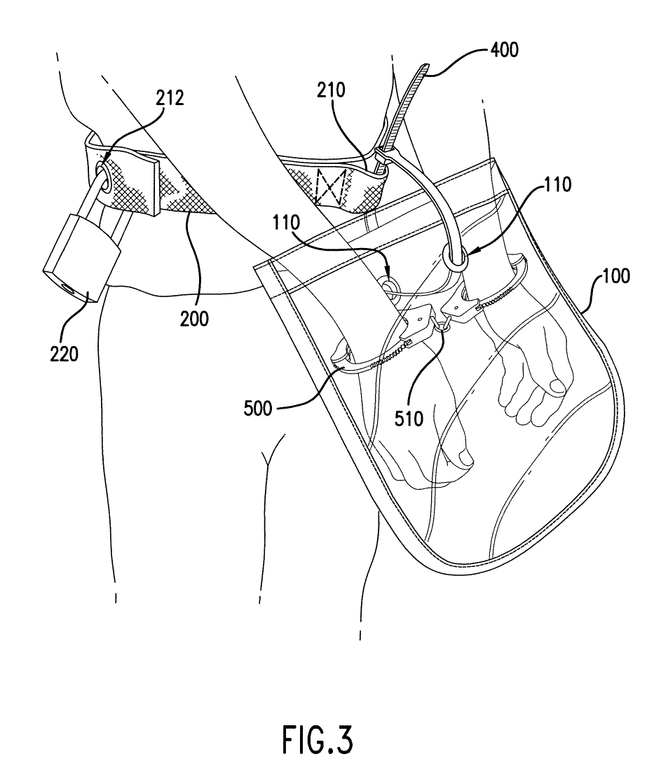

FIG. 3 depicts a variation of a restraint system according to an exemplary embodiment of the present invention. The restraint system further includes a belt 200 having a restraining loop 210 and plurality of holes 212. The plurality of holes 212 allow the belt to be adjusted according to differing waist sizes. The belt 200 is wrapped around the waist of the person and secured to the person be aligning a pair of holes 212 and extending a fastener 220 through the pair of holes 212. The fastener 220 ensures the belt is effectively secured to the person. The fastener 220 depicted in FIG. 3 is a padlock. However, using the teachings disclosed herein, one of ordinary skill in the art should understand that other fasteners known in the art may be used including, for example, a lock tie. Another method for securing the belt to the person includes separating the stitching of the belt so as to create a loop at one end of the belt. A fastener may be threaded through this loop and secured to an opposing section of the belt 200. This also allows the belt 200 to be adjusted according to varying waste sizes. Once the belt 200 is secured to the person, the enclosure 100 is connected to the belt 200 by extending a fastening element 400 through the restraining loop 210 and each aperture 110 of the walls 130 and 140 of the enclosure 100. This further restricts the movement of the hands and handcuffs 500 of the person, allowing for the safe transportation or detainment of a person to be secured.

In another exemplary embodiment of the present invention, the enclosure 100 further comprises a strap with one end attached to the bottom of the enclosure 100. The opposing end of the strap is threaded between the legs and up the backside of the person to be secured. The free end of the strap is threaded around the belt 200 and secured to itself with a fastening means, such as a Velcro® material, a padlock, or a lock tie. This additional strap keeps the person to be secured from pulling the belt 200 up on the body.

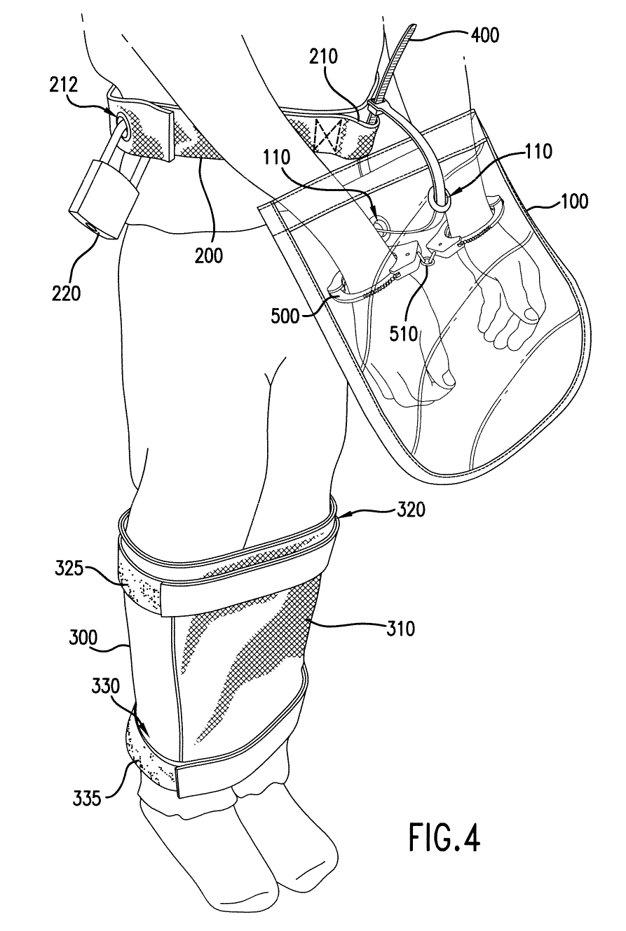

FIG. 4 depicts yet another variation of an exemplary embodiment of a restraint system according to the present invention. The restraint system includes a leg wrap 300. The leg wrap 300 has a fabric member 310 that is configured to be completely wrapped around the legs of the person. The fabric member 310 may be formed from a variety of materials including a vented mesh material to allow the legs of the person to breathe. The fabric member 310 defines an upper position 320 and a lower position 330. The leg wrap 300 includes a first strap 325 connected to the upper position 320 and a second strap 335 connected to the lower position 330. The straps may comprise a Velcro® material for fastening. However, using the teachings disclosed herein, one of ordinary skill in the art should appreciate that other methods for fastening the straps known in the art may also be utilized. As shown in FIG. 1, the leg wrap 300 may also include corresponding Velcro® sections 350 disposed on the edges of the fabric member 310 to facilitate securing the leg wrap 300 around the legs of the person to be restrained.

The leg wrap 300 is secured to the person by completely wrapping the fabric member 310 around the legs of the person. When wrapped around the legs of the person, the upper position 320 of the fabric member 310 is located below the person's knees and the lower position 330 is located between the person's knees and ankles. The leg wrap is secured by fastening the first and second straps 325 and 335. If the leg wrap includes the Velcro® section 350 as shown in FIG. 1, the leg wrap is further secured around the legs of the person by aligning corresponding Velcro® sections 350. Once the leg wrap 300 is secured to the person, the movement of the person's legs is effectively inhibited. This limits the possibility of escape and injury that may arising from otherwise leaving the legs free of any restraints.

While the present subject matter has been described in detail with respect to specific exemplary embodiments and methods thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. A restraint system for securing a person, the person having hands restrained by handcuffs joined by a connecting element, the restraint system comprising:
an enclosure configured to receive and surround the handcuffs and hands of the person, the enclosure having a pair of walls defining an opening for insertion and removal of the handcuffs and hands, each said wall also having a top peripheral edge and defining an aperture spaced apart from the top peripheral edge;
a fastening element extending through each aperture of said pair of walls and encircling the opening and the top peripheral edges of said pair of walls without encircling the connecting element of the handcuffs.

2. The restraint system of claim 1, wherein each said aperture comprises grommets formed from a polymer.

3. The restraint system of claim 1, wherein one of said pair of walls is formed from a transparent vinyl material.

4. The restraint system of claim 1, wherein said walls are formed from a treated synthetic material, the treated synthetic material configured to retain bodily fluids and residue from the hands of the person to be secured.

5. The restraint system of claim 1, wherein the enclosure defines a base and further comprises a seam extending from said base to a position spaced below each said aperture, the seam connecting the pair of walls of the enclosure so that the hands of the person are separated from each other when said enclosure receives and surrounds the handcuffs and hands of the person.

6. The restraint system of claim 1, wherein the restraint further comprises a belt, the belt comprising a restraining loop, wherein the belt is connected to the enclosure by extending the fastening element through the restraining loop and each aperture of said pair of walls.

7. The restraint system of claim 6, wherein the belt further comprises means for securing the belt to the person to be secured.

8. The restraint system of claim 1, wherein the restraint further comprises a leg wrap, the leg wrap comprising:
a fabric member, the fabric member configured to be completely wrapped around the legs of a person, the fabric member extending from an upper position below the person's knees to a lower position between the person's knees and ankles when wrapped around the legs of the person; and
a pair of straps connected to said fabric member, the leg wrap being secured to the person by fastening said straps.

9. The restraint system of claim 5, wherein the restraint further comprises a belt, the belt comprising a restraining loop and means for securing the belt to the person to be secured, the belt connected to the bag by extending the fastening element through the restraining loop and each aperture of said pair of walls.

10. The restraint system of claim 7, the restraint further comprising a leg wrap, the leg wrap comprising:
a fabric member, the fabric member configured to be completely wrapped around the legs of a person, the fabric member extending from an upper position below the person's knees to a lower position between the person's knees and ankles when wrapped around the legs of the person; and
a pair of straps connected to said fabric member, the leg wrap being secured to the person by fastening said straps.

11. A method for securing a person having hands restrained by handcuffs joined by a connecting element, the method comprising:
placing an enclosure around the handcuffs and hands of the person so that the enclosure surrounds the handcuffs and hands of the person, the enclosure having a pair of walls defining an opening for insertion and removal of the handcuffs and hands, each said wall also having a top peripheral edge and defining an aperture spaced apart from the top peripheral edge;
extending a fastening element through each aperture of said pair of walls and encircling the opening and top peripheral edges of said pair of walls without encircling the connecting element of the handcuffs; and
fastening said fastening element to restrict the movement of the handcuffs and hands of the person.

12. The method of claim 11, wherein the enclosure defines a base and further comprises a seam extending from said base to a position spaced below each said aperture, the seam connecting the pair of walls of the enclosure so that the hands of the person are separated from each other when said enclosure receives and surrounds the handcuffs and hands of the person.

13. The method of claim 11, wherein the method further comprises:
connecting a belt comprising a restraining loop and at least one pair of holes to the enclosure by extending the fastening element through the restraining loop and each aperture of said pair of walls; and
securing the belt to the person by extending a fastener through said pair of holes.

14. The method of claim 11, wherein the method further comprises:
wrapping a leg wrap around the legs of the person, the leg wrap comprising a fabric member configured to be completely wrapped around the legs of the person, the fabric member extending from an upper position below the person's knees to a lower position between the person's knees and ankles when wrapped around the legs of the person, and a pair of straps connected to said fabric member; and
securing the leg wrap to the person by fastening said straps connected to the fabric member.

15. The method of claim 13, wherein the method further comprises:
wrapping a leg wrap around the legs of the person, the leg wrap comprising a fabric member configured to be completely wrapped around the legs of the person, the fabric member extending from an upper position below the person's knees to a lower position between the person's knees and ankles when wrapped around the legs of the person, and a pair of straps connected to said fabric member; and
securing the leg wrap to the person by fastening said straps connected to the fabric member.

16. The method of claim 12, wherein the method further comprises:
connecting a belt comprising a restraining loop and at least one pair of holes to the enclosure by extending the fastening element through the restraining loop and each aperture of said pair of walls; and
securing the belt to the person by extending a fastener through said pair of holes.

17. The method of claim 16, wherein the method further comprises:
wrapping a leg wrap around the legs of the person, the leg wrap comprising a fabric member configured to be completely wrapped around the legs of the person, the fabric member extending from an upper position below the person's knees to a lower position between the person's knees and ankles when wrapped around the legs of the person, and a pair of straps connected to said fabric member; and
securing the leg wrap to the person by fastening said straps connected to the fabric member.

18. A restraint for securing a person, the person having hands secured by hand restraints joined by a link member, the restraint comprising:
a leg wrap member defining an upper portion and a lower portion, the leg wrap member comprising a first fastening strap connected to said upper portion and a second fastening strap connected to said lower portion, wherein the leg wrap member is configured to be completely wrapped around the legs of a person, the upper portion of said leg wrap member being located below the person's knees and the lower portion of said leg wrap member being located between the person's knees and ankles when wrapped around the legs of the person.

19. The restraint of claim 18, wherein the restraint further comprises a fabric enclosure configured to receive and surround the hand restraints and hands of the person, the fabric enclosure having a pair of opposing walls, the opposing walls defining an opening for insertion and removal of the hand restraints and hands, each said opposing wall defining a top peripheral edge and an aperture spaced below the top peripheral edge; and
a fastening element extending through each aperture of said pair of walls and encircling the opening and top peripheral edges of said pair of walls without encircling the link member of the hand restraints.

20. The restraint of claim 19, wherein the restraint further comprises a belt, the belt comprising a securing loop, wherein the belt is connected to the fabric enclosure by extending the fastening element through the securing loop and each aperture of said opposing walls.
